(19) United States
(12) Patent Application Publication
(10) Pub. No.: US 2020/0301962 A1
(43) Pub. Date: Sep. 24, 2020

(54) System and Method For Recommending Visual-Map Based Playlists

(71) Applicant: Shubhangi Mahadeo Jadhav, Utrecht (NL)

(72) Inventors: Shubhangi Mahadeo Jadhav, Utrecht (NL); Kahul Kashinathrao Dahule, Utrecht (NL)

(21) Appl. No.: 16/768,197

(22) PCT Filed: Oct. 3, 2018
(86) PCT No.: PCT/IB2018/057679

§ 371 Date: May 29, 2020

(30) Foreign Application Priority Data
Dec. 9, 2017 (IN) 201721044298

(51) Int. Cl. G06F 16/638; G06F 16/635

(52) U.S. Cl. CPC G06F 16/639; G06F 16/635

(57) ABSTRACT

The present disclosure pertains to recommendation of playlists having data elements on visual maps to a user. The proposed method comprises receiving a search query comprising a data element; retrieving attributes associated with the data element; mapping the data element on pre-set visual maps that overlap with the data element and/or with the associated attributes; assigning weight to each mapped pre-set visual map based on extent of contextual overlap between the search query and the respective pre-set visual map; and recommending the mapped pre-set visual maps based on weight associated with each of the retrieved pre-set visual maps, each recommended map comprising one or more data elements, at least a set of which data elements being logically connected to form the recommended playlist for the user based on user profile, said set of selected data elements being connected so as to form a trajectory to be presented as the playlist.

### TECHNICAL FIELD

The present disclosure in general relates to recommendation of playlists comprising data elements of any kind. More specifically, the present disclosure relates to systems and methods for recommending contextual visual maps along with the embedded playlists therein.

### BACKGROUND

With the advent of Internet and rise of social networks, a variety of data is becoming available and accessible. Examples of such data include media content, for example, digital video, digital audio, digital photos, devotional content, educational content, sports content, gaming content, e-reading content, and fashion related content. From the variety of data, it is becoming difficult to find favourite data. For example, with respect to digital audio, it is to be expected that at some point in time, substantially all music will be available online, for example, through online music portal websites. With potentially billions of music tracks from new and existing artists being added to the worldwide online available music collection on a monthly time scale, it is becoming extremely difficult to find favourite music tracks or new music tracks to ones liking from the vast collection of music.

U.S. Pat. No. 9,747,009 discloses a user-friendly graphical user interface that enables creation of a playlist of data elements (data elements including music/audio songs/tracks), where the playlist is represented as a logical multi-dimensional music map having the plurality of data elements that are connected to each other so as to form a trajectory. The trajectory comprises a start point data element, an end point data element, and one or more intermediate data elements that are changed by moving a steering point. Therefore, this reference focuses only on creation and modification of a playlist on an existing contextual visual map. However, with exponentially growing number of data elements, problems such as which music map to listen to, and which data elements of each music map to be played are becoming increasing hard to solve, and are not being addressed by any current technical solution as in existing solutions, users need to search for individual data elements and create their own preferred playlists, which increases the complexity of the desired solution. As a result, it can be expected that with growing number of digital media items (also interchangeably referred to as data elements) for example, growing number of new songs or growing number of new artists, more and more logical/contextual maps will be created and saved to database, which would increase the complexity of searching with respect to a desired data element to an extent that the data element being searched may appear in thousands of saved contextual music maps. Some maps may not have been saved, and therefore need to be created on automatically. Further to this complexity, the desired data element being searched may have been arranged on multi-dimensional contextual maps having varied types/attributes of data element, making it a very time consuming step to browse all the contextual maps, and filter context of the browsed maps, and then filter the connected data elements in the filtered maps so as to then create a playlist trajectory covering the desired data elements, which may have been arranged in 1D (one-dimension) or 2D (two-dimension).

There is therefore a need in the art for systems and methods that allow users to search for music maps, be presented with one or more recommended music maps, and also adjust trajectory of data elements that form part of each recommended map in an order to make it easier to search and play music tracks and other data elements as mentioned above.

### SUMMARY

This summary is provided to introduce concepts related to for recommending a playlist comprising a plurality of data elements. The concepts are further described below in the detailed description. This summary is not intended to identify key features or essential features of the claimed subject matter, nor is it intended to be used to limit the scope of the claimed subject matter.

In an aspect, the present disclosure relates to a computer-implemented method for recommending a playlist comprising a plurality of data elements, wherein each of the plurality of data elements is associated with metadata that represents at least one attribute of the data element. In an aspect, the proposed method can include the steps of receiving, at a computing system, a search query comprising at least one data element or at least one attribute associated with the data element; searching and retrieving, in or from a database operatively coupled with the computing system over a network, attributes associated with at least one data element; and mapping the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. In response to affirmative ascertaining, the method can further include the steps of retrieving the pre-set visual maps that overlap with the data element and with the associated attributes, wherein the retrieved pre-set visual maps can include a Cartesian or a Polar coordinate system based model for classification of the attributes, each retrieved pre-set visual map being segmented into portions representing at least one of the attributes connected to the searched query based on contextual association; computing and assigning weights to each of the retrieved pre-set visual maps based on the extent of contextual overlap or relevance between the search query and the respective pre-set visual map, the highest weight being associated with the map having maximum overlap or relevance; and recommending, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, wherein the set of selected data elements is connected so as to form a trajectory to be presented as the playlist to the user, wherein the trajectory comprises a first data element that is representative of starting point of the trajectory, and wherein the first data element pertains to the data element received as part of the search query.

In an aspect, the present disclosure further relates to a computer implemented method for recommending a playlist that comprises a plurality of data elements, where each of the plurality of data elements can be associated with metadata representing at least one attribute of the data element. The proposed method can include the steps of receiving, at a computing system, a search query comprising at least one data element or at least one attribute associated with the data element; searching and retrieving, in or from a database operatively coupled with the computing system over a network, attributes associated with the at least one data element; and mapping the data element and the associated attributes on pre-set visual maps in real time for ascertaining whether the number of pre-set visual maps overlapping with the data element and the associated attributes exist above a threshold limit within the database. In response to negative ascertaining, the proposed method can further include the step of automatically generating a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query. The number of automatically generated visual maps may vary in their numbers, also may vary based on the logically associated contexts, and the number of dimension in which the data elements are grouped in linear or radial direction.

In an aspect, the present disclosure further pertains to a system for recommending a playlist comprising a plurality of data elements, where each of the plurality of data elements can be associated with metadata representing at least one attribute of the data element. The proposed system can include a non-transitory storage device having embodied therein one or more routines operable to recommend the playlist; and one or more processors coupled to the non-transitory storage device and operable to execute the one or more routines, wherein the one or more routines can include: a search query receive module, which when executed by the one or more processors, receives a search query comprising at least one data element or at least one attribute associated with the data element; a search query based attributes retrieval module, which when executed by the one or more processors, searches and retrieves, in or from a database, attributes associated with at least one data element; and a pre-set visual map based mapping module, which when executed by the one or more processors, maps the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. In response to affirmative ascertaining, the proposed system can be configured to retrieve the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association; compute and assigns weights to each of the retrieved pre-set visual maps based on the extent of contextual overlap or relevance between the search query and the respective pre-set visual map, highest weight being associated with the map having maximum overlap or relevance; and recommend, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

In an aspect, the present disclosure further pertains to a system for recommending a playlist comprising a plurality of data elements, where each of the plurality of data elements can be associated with metadata representing at least one attribute of the data element. The proposed system can include a search query receive module, which when executed by the one or more processors, receives a search query comprising at least one data element or at least one attribute associated with the data element; a search query based attributes retrieval module, which when executed by the one or more processors, searches and retrieves, in or from a database, attributes associated with at least one data element; a pre-set visual map based mapping module, which when executed by the one or more processors, maps the data element and the associated attributes on pre-set visual maps in real time for ascertaining whether the number of pre-set visual maps that overlap with the data element and with the associated attributes is above a predefined threshold limit within the database. In response to negative ascertaining, the proposed system can automatically generate a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein, wherein:

FIG. 1 illustrates an exemplary architecture for recommendation of one or more pre-set visual maps in the form of a playlist having data elements in accordance with an exemplary embodiment of the present disclosure.

FIG. 2 illustrates an exemplary representation showing how a query having a data element can be received by the proposed system in accordance with an exemplary embodiment of the present disclosure;

FIGS. 3A-3C illustrates exemplary pre-set visual maps in accordance with an exemplary embodiment of the present disclosure.

FIGS. 4A-4C illustrate exemplary first and the last control points in a mathematical spine function over visual maps in accordance with an exemplary embodiment of the present disclosure;

FIG. 5 illustrates various exemplary components of a proposed system in accordance with an exemplary embodiment of the present disclosure;

FIGS. 6A-6B illustrate exemplary visual maps being segmented into six even-sized portions in accordance with an exemplary embodiment of the present disclosure;

FIGS. 7A-7B illustrate exemplary visual maps with control points for editing a recommended playlist in accordance with an exemplary embodiment of the present disclosure;

FIGS. 8-10 illustrate exemplary hybrid maps along with the recommended playlist with the first and last control points in accordance with an exemplary embodiment of the present disclosure;

FIG. 11 an exemplary flow diagram illustrating a method of recommending a playlist for pre-set visual maps in accordance with an exemplary embodiment of the present disclosure; and

FIG. 12 illustrates another exemplary flow diagram illustrating a method of recommending a playlist for automatically generated visual maps in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Various terms as used herein are shown below. To the extent a term used in a claim is not defined below, it should be given the broadest definition persons in the pertinent art have given that term as reflected in printed publications and issued patents at the time of filing.

This summary is provided to introduce concepts related to for recommending a playlist comprising a plurality of data elements. The concepts are further described below in the detailed description. This summary is not intended to identify key features or essential features of the claimed subject matter, nor is it intended to be used to limit the scope of the claimed subject matter.

In an aspect, the present disclosure relates to a computer-implemented method for recommending a playlist comprising a plurality of data elements, wherein each of the plurality of data elements is associated with metadata that represents at least one attribute of the data element. In an aspect, the proposed method can include the steps of receiving, at a computing system, a search query comprising at least one data element or at least one attribute associated with the data element; searching and retrieving, in or from a database operatively coupled with the computing system over a network, attributes associated with at least one data element; and mapping the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. In response to affirmative ascertaining, the method can further include the steps of retrieving the pre-set visual maps that overlap with the data element and with the associated attributes, wherein the retrieved pre-set visual maps can include a Cartesian or a Polar coordinate system based model for classification of the attributes, each retrieved pre-set visual map being segmented into portions representing at least one of the attributes connected to the searched query based on contextual association; computing and assigning weights to each of the retrieved pre-set visual maps based on the extent of contextual overlap or relevance between the search query and the respective pre-set visual map, the highest weight being associated with the map having maximum overlap or relevance; and recommending, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, wherein the set of selected data elements is connected so as to form a trajectory to be presented as the playlist to the user, wherein the trajectory comprises a first data element that is representative of starting point of the trajectory, and wherein the first data element pertains to the data element received as part of the search query.

In an aspect, each of the one or more data elements that form part of each recommended pre-set visual map can be associated with a weight based on the user profile or user preferences in a manner such that the data element with the highest weight becomes the first data element and the starting point of the trajectory. In another aspect, data elements that have an associated weight lower than a defined threshold do not form part of the trajectory.

In another aspect, the user profile can include any or a combination of historical data elements that formed part of previously recommended playlists, user demographic profile, and user psychographic profile.

In another aspect, the attributes can include any or a combination of artist's name, artist's gender, artist's language, artist's country of origin, artist's genre type, contribution of the artist among the three types of original artist, cover artist or featured artist, a single genre type, a mixed genre type, a mood type, a valence of mood type, a language, rhythm related inputs type, an activity type, version type among original, explicit, extended, cover or remix, year of release, month of release, and an instrumental related inputs type.

In another aspect, the pre-set visual maps can be previously prepared (i.e. pre-prepared), and saved in the database by any or both of an expert and the user, wherein the pre-set visual maps can be ranked based on one of a social ranking, a user ranking, or an aggregate of both social and user rankings.

In yet another aspect, the database can be updated in real-time for the addition of new pre-set visual maps by the experts or the users.

In yet another aspect, the search query can be received in the form of or processed from any or a combination of a keyword, a video clip, an image, or an audio.

In an aspect, the search query can be processed through a network based voice service that can be coupled with the computing device that is capable of processing a voice based search query.

In yet another aspect, the data element can be any or a combination of a music track, an audio song, a video, a photo, a news item, and informative item, a game, an e-book, and an e-cartoon.

In another aspect, the type of mood or intensity of mood or variation of tempo, or language or year of release falling within a particular decade of the data elements represented in the pre-set visual maps can vary in a radial or a linear direction from centre of the pre-set visual maps to the outer periphery of the pre-set visual maps.

In yet another aspect, each of the pre-set visual maps can be one of a circular-shaped map, square-shaped map, and a rectangular-shaped map.

In yet another aspect, wherein the method can include the step of locally caching, at the computing device, the meta-data representing at least one attribute of the data element while the playlist has been recommended to the user; and processing the local cache when a further search query is received from the user.

In yet another aspect, the retrieved pre-set visual map having the highest weight can be recommended first to the user.

In an aspect, the present disclosure further relates to a computer implemented method for recommending a playlist that comprises a plurality of data elements, where each of the plurality of data elements can be associated with metadata representing at least one attribute of the data element. The proposed method can include the steps of receiving, at a computing system, a search query comprising at least one data element or at least one attribute associated with the data element; searching and retrieving, in or from a database operatively coupled with the computing system over a network, attributes associated with the at least one data element; and mapping the data element and the associated attributes on pre-set visual maps in real time for ascertaining whether the number of pre-set visual maps overlapping with the data element and the associated attributes exist above a threshold limit within the database. In response to negative ascertaining, the proposed method can further include the step of automatically generating a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query. The number of automatically generated visual maps may vary in their numbers, also may vary based on the logically associated contexts, and the number of dimension in which the data elements are grouped in linear or radial direction.

In an aspect, each of the set of data elements can be associated with a weight based on their contextual relationship or relevance to the at least one data element or the at least one attribute associated with the data element that form part of the search query, wherein the plurality of data elements are selected from the set of data elements based on the associated weight.

In yet another aspect, each of the plurality of data elements can be associated with a rank based on user profile or user preferences such that starting point of the trajectory is the data element having the highest rank.

In an aspect, the present disclosure further pertains to a system for recommending a playlist comprising a plurality of data elements, where each of the plurality of data elements can be associated with metadata representing at least one attribute of the data element. The proposed system can include a non-transitory storage device having embodied therein one or more routines operable to recommend the playlist; and one or more processors coupled to the non-transitory storage device and operable to execute the one or more routines, wherein the one or more routines can include: a search query receive module, which when executed by the one or more processors, receives a search query comprising at least one data element or at least one attribute associated with the data element; a search query based attributes retrieval module, which when executed by the one or more processors, searches and retrieves, in or from a database, attributes associated with at least one data element; and a pre-set visual map based mapping module, which when executed by the one or more processors, maps the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. In response to affirmative ascertaining, the proposed system can be configured to retrieve the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association; compute and assigns weights to each of the retrieved pre-set visual maps based on the extent of contextual overlap or relevance between the search query and the respective pre-set visual map, highest weight being associated with the map having maximum overlap or relevance; and recommend, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

In an aspect, the present disclosure further pertains to a system for recommending a playlist comprising a plurality of data elements, where each of the plurality of data elements can be associated with metadata representing at least one attribute of the data element. The proposed system can include a search query receive module, which when executed by the one or more processors, receives a search query comprising at least one data element or at least one attribute associated with the data element; a search query based attributes retrieval module, which when executed by the one or more processors, searches and retrieves, in or from a database, attributes associated with at least one data element; a pre-set visual map based mapping module, which when executed by the one or more processors, maps the data element and the associated attributes on pre-set visual maps in real time for ascertaining whether the number of pre-set visual maps that overlap with the data element and with the associated attributes is above a predefined threshold limit within the database. In response to negative ascertaining, the proposed system can automatically generate a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query.

### Definitions

As used in the disclosure, a graphical user interface can be understood as a user interface or any representation to support a user to select/enter one or more data elements to be included in a playlist. The graphical user interface is typically part of a web page, an online application, a software application for use on, for example, a PC, notebook, smart phone or tablet PC, or an application plug-in. Known graphical user interfaces for creating or recommending playlists are found to be either difficult to use, difficult to learn or requiring a lot of user interaction.

Playlist in the present disclosure may be a list and/or an order of different data elements (such as music tracks) that can be viewed/heard/interacted with in sequence or can be shuffled without interaction from a user. The user may navigate or transition between the data elements/items on a playlist. For example, the user may wait for a next data element on the playlist to play or may select a particular data element in the playlist.

Visual maps are two or three-dimensional representations of one or more playlists, and therefore as a result graphically show/depict the data elements that form part of each playlist. Although, aspects of the present disclosure have been explained in a manner such that each map corresponds to one playlist, it is very much possible and within the scope of the invention to have each map be representative of multiple playlists or one playlist to be represented through a plurality of maps. Furthermore, each map can have a different graphical representation based on, for instance, type of data elements (such as music tracks, videos, photos, games, sport content, educational content, etc.) being represented, and data element attributes such as mood, arousal-valence, or tempo-decade characteristics. It is to be understood that the present disclosure is not limited to these visual maps and their related data elements. In an aspect, outer shape of the content based visual maps can be any 2D shape such as a square, a circle or a rectangle, or can be rendered in an appropriate 3D shape.

Although the description herein is focussed majorly on data elements of visual maps being music tracks, the present disclosure is equally applicable to other data elements such as a video, a photo, a news item, and informative item, a game, an e-book, and an e-cartoon.

The present disclosure in general relates to recommendation of playlists comprising data elements of any kind. More specifically, the present disclosure relates to systems and methods for recommending contextual visual maps along with the embedded playlists therein. Such recommendation is performed, as mentioned above, based on a search query received by the proposed system, said query comprising a data element or an attribute thereof, for instance, the name of an artist, or a music track, or a genre, or a combination thereof, wherein the objective of running such a search query is, for a user, to receive one or more playlists that contextually match with the data element that forms part of the search query. For instance, if a user enters an artist name “Madonna” in a search query, objective of the user is to receive one or more playlists (represented by the present system in the form of corresponding/respective pre-set visual maps) that either contain music tracks of Madonna, or contain such music tracks that match attributes of Madonna i.e. they have tracks played by artists that have similar genre to Madonna, or sing similar songs, or were played during the same time when Madonna sung, or have similar characteristics.

As mentioned above, it is to be appreciated that the search query can include a data element, or can even include an attribute of the data element i.e. instead of receiving artist/band name such as Metallica or name of the song/track such as “Sad But True”, the system can receive attributes such as “Rock Songs”, “Soft Jazz”, etc, and therefore, in the instant specification, reference to the term “data element” as part of a search query should be construed to include the possibility of one or more attributes of the data element to be received as part of the query as well.

The present disclosure relates to methods and systems for recommending one or more playlists (in the form of pre-set visual maps of 2 or 3 dimensions), each playlist include a plurality of data elements. As described above, a data element of a playlist can be a music track, a video, a photo, a news item, an informative item, a game, an e-book, an e-cartoon, and so forth. Further, each data element can be associated with meta-data representing at least one attribute of the data element. An attribute of the data element can be at least one or a combination of artist's name, artist's gender, artist's language, artist's country of origin, artist's genre type, contribution of the artist among the three types of original artist, cover artist or featured artist, a mixed genre type, a mood type, a valence of mood type, a language, rhythm related inputs type, an activity type, version type among original, cover or remix, year of release, month of release, and an instrumental related inputs type. Further, the meta-data representing at least one attribute of the data element may be locally cached at a computing system while the playlist has been recommended to the user, and the locally cached meta-data may be processed when a search query is received from the user at the computing system.

In an aspect of the present disclosure, the proposed method may initiate with receiving a search query for at least one data element from a user at graphical user interface of the computing system. In an example, the computing system can be a server managing an online music portal and the graphical user interface can be a user interface of the data units, such as digital content. Further, the search query can be received or inputted via a keyword, a processing of a video clip, an image, an audio to extract the inputted query, and the like. Yet further, the search query may be processed through voice command processing devices coupled to the computing system, where the voice command processing devices are being capable of processing a voice search query.

Once the search query is received, the database/repository of the computing system (as a of a server) or operatively coupled with the computing system can be searched for retrieving attributes associated with at least on data element of the search query. Upon retrieval of attributes of the received data element, the data element and/or the associated attributes may be mapped on pre-set visual maps in real-time for ascertaining whether the number of pre-set visual maps overlapping with the data element and the associated attributes exist above a predefined threshold limit revealed from querying the database. The database may be updated in real time for the addition of new pre-set visual maps prepared by the experts or the users. In an aspect, the threshold can be configured dynamically (based on the data element being searched for) or can be set manually or can be kept fixed, all of which possibilities are well within the scope of the present invention.

In an aspect, the pre-set visual maps can be based on Cartesian or Polar coordinate system and used for classification of attributes, where each pre-set visual map can be segmented into even-sized portions representing one of the attributes connected based on contextual association to the searched query. Therefore, each map can include one or more instances of the data element being searched for along with instances of other data elements that are contextually relevant to the attributes associated with the searched data element. In an aspect, the pre-set visual maps may be previously prepared and saved in the database by one or more experts and/or by the user, or the users who are socially connected in a given online network.

Once a set of pre-set visual maps that map with the searched data element (or associated attributes) are obtained, such obtained maps can be ranked based on any or a combination of a social ranking, a user ranking, or an aggregate of both social and user rankings, or based on extent of contextual overlap in the each map with respect to the entered data element or attributes thereof. For instance, for a search query having “Metallica” as the data element, a pre-set visual map that has the maximum data elements pertaining to Metallica and attributes of Metallica would be ranked higher in a manner such that the higher ranked/weighted maps based on their extent of contextual overlap or relevance to Metallica are more recommended than the other maps.

In an alternative or another aspect of the present disclosure, when it is ascertained that there are no pre-set visual maps overlapping with the data element and the associated attributes during mapping of the data element and the associated attributes on pre-set visual maps in real time, visual maps subject to results derived from the pre-defined rules may be automatically generated. In an example, the said rules may be previously stored in the database and the said rules may get updated in the real time along with the new additions of the rules and may be used to extract contextual data elements related to data element received in the search query as an output from the pre-defined rules. Further, in an implementation of said alternative or another aspect, the visual maps may be automatically generated by searching and retrieving, in or from the database, the data elements having contextual relationship with the data element received in the search query, followed by establishing and categorizing the result of different contextual relationships among the searched data element with retrieved data elements that are found under a common contextual relationship. Then, for each of the established and categorized relationship, computation and assignment of weights are performed for each of the retrieved data elements and arranging them in an ascending or descending order, where their respective weights are ranked based on an aggregated value derived from the ranking related inputs from the experts along with the ranking related inputs gathered from social and user interactions. Based on the computed and assigned weights to each of the retrieved data elements, a number of different visual maps categorized on the grounds of matching of the similar context are generated by incorporating the searched data element in combination with the variable number of contextual data elements that are selected based on their rankings within each of the category. In an example, the resulted visual maps are one or a combination of one dimensional visual maps and two dimensional visual maps. The visual maps are being a Cartesian coordinate system based model or a Polar coordinate system based model for classification of the attributes, each visual map being segmented into even-sized portions and is always representing the searched data element with any associated attribute and connected with related data elements with any associated attributes.

Then, in both the above mentioned aspects, i.e. in case of pre-set visual maps and automatically generated visual maps, a starting point may be affixed at a first coordinate on the visual maps for recommending the playlist. In an example, the starting point can be representing the data element received in the search query or representing the data element received in the search query in combination with its related attribute, and can be corresponding to the highest rank of the computed weight of the said combination.

Following the affixing of the starting point, in each visual map, weights of the rest of the connected data elements with or without the combination are arranged with their related and respective attributes in a particular ascending or descending order from the starting point. Based on the arranged weights, on the visual maps, the affixation is performed of an end point equalling the lowest value of the ordered weights and representing the respective end data element at a second coordinate and one or more predefined intermediate points equalling the intermediate values of the ordered weights and representing one or more intermediate data elements at one or more intermediate coordinates between the first coordinate and the second coordinate. In an example, the affixation of the end point and the intermediate points is performed in such a way that each of the even-sized portions is covered by a mathematical spline function representing playlist trajectory connecting the starting point and the end point through the one or more predefined number of the intermediate points.

Thereafter, the coordinates associated with the starting point, the end point, and the one or more predefined number of the intermediate points, may be calculated as control points in the mathematical spline function. The calculation of the control points may be followed by displaying the said visual maps along with respective contextual relationship and recommended playlist trajectory covering the said coordinates required to form the mathematical spline function. In an example, the visual maps are displayed respectively in a decreasing ranking order, in which the calculation of the rank of the visual maps is based on an aggregated value derived from the ranking related inputs from the experts along with the ranking related inputs gathered from social and user interactions.

In an example, once the maps are recommended to the user based on their rank/weight (based on contextual overlap/relevance between the searched data element and the pre-set maps stored in the database), each map can include one or more data elements, a set of which can be selected based on user profile, past user preferences, user historical behaviour, among other user defined parameters, which set of selected data elements can then be connected with each other so as to form a trajectory of data elements, said trajectory forming the playlist is actually played for the user upon selection of the map. Therefore, each map can include a playlist but all data elements of the map may not form part of the playlist. For instance, a map may include 10 music tracks, 2 of which may not be preferred by the user based on his previous choices, and therefore only 8 tracks are finally selected and connected to each other in sequence of their relevance so as to form a trajectory that results in the actual playlist.

In another aspect, the proposed method may by a system having a non-transitory storage device having embodied therein one or more routines operable to recommend the playlist, and one or more processors coupled to the non-transitory storage device and operable to execute the one or more routines. The routines may include a querying engine to receive a search query with at least one data element, say, ‘Katy Perry’ on a user interface (graphical user interface) of an online music streaming portal (computing system). Based on the received data element, the querying engine may search and retrieve, in or from the database, affiliated attributes of the inputted data element. For instance, if the data element is ‘Katy Perry’, then connected/similar/associated attributes can be international artist, female singer, pop+rock singer, English, American, Decades, total number of songs/albums, her happy songs, her sad songs, and so forth. That is, if the search query input is a music track, then the database may be queried to extract connected attributes such as artist's name, artist's gender, artist's language, artist's country of origin, artist's genre type, contribution of the artist among the three types of original artist, cover artist or featured artist, a mixed genre type, a mood type, a valence of mood type, a language, rhythm related inputs type, an activity type, version type among original, cover or remix, year of release, month of release, and an instrumental related inputs type.

Based on the data element and the associated attributes, the routines may trigger its real time monitoring engine to map the data element and the associated attributes on pre-set visual maps in real time for ascertaining whether the number of pre-set visual maps overlapping with the data element and the associated attributes exist above a predefined threshold limit revealed from querying the database, where the pre-set visual maps are one or a combination of one dimensional and two dimensional visual maps. For example, for data element ‘Katy Perry’, the real time monitoring engine may map ‘Katy Perry’ and its associated attributes on the previously stored or pre-set visual maps to ascertain whether the number of pre-set visual maps having ‘Katy Perry’ and its associated attributes are above a predefined threshold limit of five (5) visual maps.

In an implementation, in case the number of ascertained pre-set visual maps is above the predefined threshold, the real time monitoring engine may retrieve the pre-set visual maps. For example, in case there are enough pre-set visual maps having ‘Katy Perry’ as one of the artists along with other associated attributes; those pre-set visual maps may be retrieved. The pre-set visual maps can be a Cartesian coordinate system based model or a Polar coordinate system based model for classification of the attributes, each pre-set visual map is being segmented into even-sized portions representing one of the attributes connected based on contextual association.

In an alternative implementation, in case the number of ascertained pre-set visual maps is below the predefined threshold, the real time monitoring engine may trigger a real time visual map generating module of the routines. In an example, in case there are no pre-stored visual maps having ‘Katy Perry’ as one of the artists, the real time visual map generating module may generate visual maps automatically subject to results derived from the pre-defined rules. The said rules may be previously stored in the database and the said rules may get updated in the real time along with the new additions of the rules and may be used to extract contextual data elements related to data element received in the search query as an output from the pre-defined rules. Further, the said rules may include predefined logical rules for establishing the respective contextual relationship, where the logical rules are defined by experts or established by rules extracted from social and user-specific engagements, and the logical rules may be updated in real time for the changes in existing rules and for the additions of new rules and are based on one of mood, genres, mixed genres, activity, year of release, month of release, similar artist, similar rhythm type, language, featured artists, and instrumental tone. In present alternative implementation real time visual map generating module may automatically generate visual maps by searching and retrieving, in or from the database, the data elements having contextual relationship with the data element received in the search query, followed by establishing and categorizing the result of different contextual relationships among the searched data element with retrieved data elements that are found under a common contextual relationship. Then, for each of the established and categorized relationship, computation and assignment of weights are performed for each of the retrieved data elements and arranging them in an ascending or descending order, where their respective weights are ranked based on an aggregated value derived from the ranking related inputs from the experts along with the ranking related inputs gathered from social and user interactions. Based on the computed and assigned weights to each of the retrieved data elements, a number of different visual maps categorized on the grounds of matching of the similar context are generated by incorporating the searched data element in combination with the variable number of contextual data elements that are selected based on their rankings within each of the category. In an example, the resulted visual maps are one or a combination of one dimensional visual maps and two dimensional visual maps. The resulted visual maps are being a Cartesian coordinate system based model or a Polar coordinate system based model for classification of the attributes, each visual map being segmented into even-sized portions and is always representing the searched data element with any associated attribute and connected with related data elements with any associated attributes.

Once the pre-set visual maps are retrieved or the automatically visual maps are generated, a playlist recommending engine of the routines may compute and assign weights to each of the retrieved visual maps and to the data elements which are arranged in one dimension or in two dimensions in combination of their respective attributes and are located at predefined coordinates within each of the pre-set visual maps. For instance, when the visual maps are retrieved, the playlist recommending engine may assign a weight value representing ranking of likings of the pre-set visual maps can be ranked based on one of a social ranking, a user ranking, or an aggregate of both social and user rankings. Further, in said example, type of mood, or intensity of mood or variation of tempo or language or year of release falling within a particular decade of the data elements represented in the pre-set visual maps varies in a radial or a linear direction from a centre of the pre-set visual maps to the outer periphery of the pre-set visual maps. Yet further, each of the pre-set visual maps can be one of a circular-shaped map, square-shaped map, and a rectangular-shaped map.

The playlist recommending engine may further affix a starting point at a first coordinate on the visual maps for recommending the playlist. In an example, the starting point can be representing the data element received in the search query or representing the data element received in the search query in combination with its related attribute, and can be corresponding to the highest rank of the computed weight of the said combination.

Following the affixing of the starting point, in each visual map, the playlist recommending engine may assign weights to the rest of the connected data elements with or without the combination are arranged with their related and respective attributes in a particular ascending or descending order from the starting point. Based on the arranged weights, on the visual maps, the affixation is performed of an end point equalling the lowest value of the ordered weights and representing the respective end data element at a second coordinate and one or more predefined intermediate points equalling the intermediate values of the ordered weights and representing one or more intermediate data elements at one or more intermediate coordinates between the first coordinate and the second coordinate. In an example, the affixation of the end point and the intermediate points is performed in such a way that each of the even-sized portions is covered by a mathematical spline function representing playlist trajectory connecting the starting point and the end point through the one or more predefined number of the intermediate points.

Thereafter, the playlist recommending engine may calculate coordinates with the starting point, the end point, and the one or more predefined number of the intermediate points, as control points in the mathematical spline function. The calculation of the control points may be followed by displaying the said visual maps along with respective contextual relationship and recommended playlist trajectory covering the said coordinates required to form the mathematical spline function. In an example, the visual maps are displayed respectively in a decreasing ranking order, in which the calculation of the rank of the visual maps is based on an aggregated value derived from the ranking related inputs from the experts along with the ranking related inputs gathered from social and user interactions.

Yet further, with the present disclosure, it may also be possible that for the purpose of play listing, a mathematical spline function is produced on the visual maps by clicking on the visual maps in a series of steps. For instance, a first click as a first user input may always correspond to the starting point, a second click as a second user input may correspond to the end point of the playlist path, a third click as a third user input may correspond to the end point of the playlist and in this case the second click may become the first control point. If there is a fourth click as a fourth user input, then it will correspond to the end point of the playlist path and third point will become the second control point, the second clicked point may become the first control point. It may be programmed to restrict the number of clicks in this proposed method. For example, three allowed clicks on a visual map shall result in a playlist path that has a starting point (first click), an end point (third click) and a control point (second click).

Yet further, the user inputs can be received via keyboard, mouse, touch screen, and/or any other user input device such as vocal or gesture recognition.

Various embodiments are further described herein with reference to the accompanying figures. It should be noted that the description and figures relate to exemplary embodiments, and should not be construed as a limitation to the subject matter of the present disclosure. It is also to be understood that various arrangements may be devised that, although not explicitly described or shown herein, embody the principles of the subject matter of the present disclosure. Moreover, all statements herein reciting principles, aspects, and embodiments of the subject matter of the present disclosure, as well as specific examples, are intended to encompass equivalents thereof. Yet further, for the sake of brevity, operation or working principles pertaining to the technical material that is known in the technical field of the present disclosure have not been described in detail so as not to unnecessarily obscure the present disclosure.

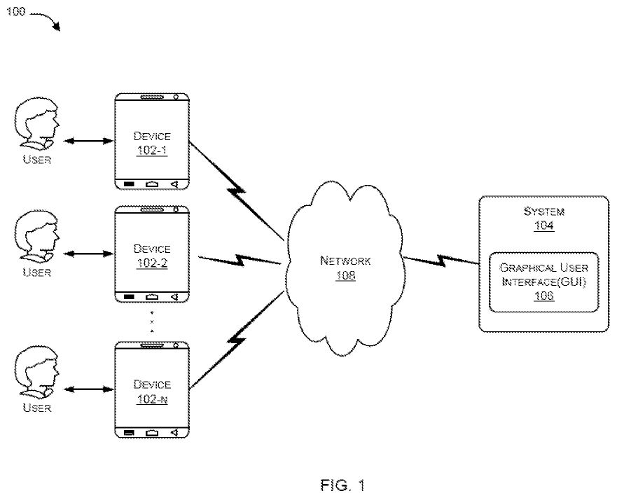

FIG. 1 illustrates an exemplary architecture 100 for recommending a playlist having a plurality of data elements, where the data elements can be a music track, a video, a photo, a news item, and informative item, a game, an e-book, an e-cartoon, and so forth.

In an aspect, the architecture 100 of the present disclosure can include a plurality of user devices 102-1, 102-2, . . . , 102-N, hereinafter collectively referred to as user devices 102 and individually as user device 102. Examples of the user devices 102 may include, but are not limited to, workstations, personal computers, personal digital assistants (PDAs), laptop computers, notebooks, smart phones, tablets, smart cameras, smart television sets, virtual assistants that listen to your users' commands and respond with contextual responses, and other smart devices. In an alternative aspect, the present approaches may also be implemented in other types of user devices without deviating from the scope of the present disclosure. In an example, the user devices 102 may communicate with other user devices 102.

The user devices 102 may be capable of communicating with a computing system 104 having a graphical user interface (GUI) 106 for accessing or playing a recommended playlist. A graphical user interface can be understood as a user interface to support a user to select one or more data elements to be included in a playlist. The graphical user interface is typically part of a web page, an online application, a software application for use on, for example, a PC, notebook, smart phone or tablet PC, or an application plug-in.

In the context of the present disclose, the playlist may be a list and/or an order of different data elements that can be viewed in sequential or shuffled order without interaction from a user. The user may navigate or transition between the data elements items on a playlist. For example, the user may wait for a next data element on the playlist to play or may select a particular data element in the playlist. Further, although the description herein is focussed majorly on data elements of the playlist being music tracks, but the present disclosure is equally applicable to other data elements such as a video, a photo, a news item, informative item, a game, an e-book, an e-cartoon, and the like.

The computing system 104 (simply referred to the system 104 hereinafter) can be an online music streaming portal and may be accessible by the user devices 102 over a communication network 108. The communication network 108 may be may be a wireless network, a wired network or a combination thereof. The communication network 108 may be implemented as one of the different types of networks, such as intranet, Local Area Network (LAN), Wide Area Network (WAN), the Internet, and the like. The communication network 108 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 108 may include a variety of network devices, including routers, bridges, servers, computing devices, storage devices, and the like.

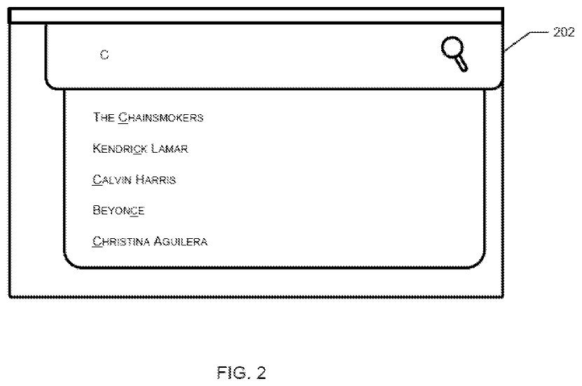

In an example, a user may be associated with the computing device 102-1. Based on such association, the user may utilize the computing device 102-1 to login to the system 104 implementing an online music streaming portal for creating a playlist of data elements such as music tracks. For creating the playlist, the user may access the GUI 106 of the online music streaming portal to submit a search query. In an example, as shown in FIG. 2, the GUI 106 can include a query receiving field 202 for receiving the search query. In said example, the search query is inputted via a keyword, or via processing of a video clip, an image, or an audio, to extract the inputted search query.

Once the search query is received by GUI 106, the system 104 may search and retrieve, in or from the database, attributes associated with at least one data element present in the inputted search query. In one example, the associated attributes can include, but not limited to, an artist's name, an artist's gender, an artist's language, an artist's country of origin, an artist's genre type, a contribution of the artist among the three types of original artist, a cover artist or featured artist, a mixed genre type, a mood type, a valence of mood type, a language, a rhythm related inputs type, an activity type, a version type among original, a cover or remix, an year of release (YOR), a month of release (MOR), and an instrumental related inputs type.

In an example, in case ‘Madonna’ is the data element of the inputted data query, then the system 104 may retrieve the attributes associated with “Madonna”. Examples of attributes associated with ‘Madonna’ can include an American singer, a song writer, a performer, genre: pop and rock, YOR: 1979-present, and so forth. Such attributes are retrieved by the system 104 from the database.

The attributes associated with ‘Madonna’ along with the data element itself may then be mapped on already stored pre-set visual maps in real-time for ascertaining whether the number of pre-set visual maps overlapping with the associated attributes exist above a predefined threshold limit. The pre-set visual maps can be previously prepared and saved in the database by one of an expert and the user.

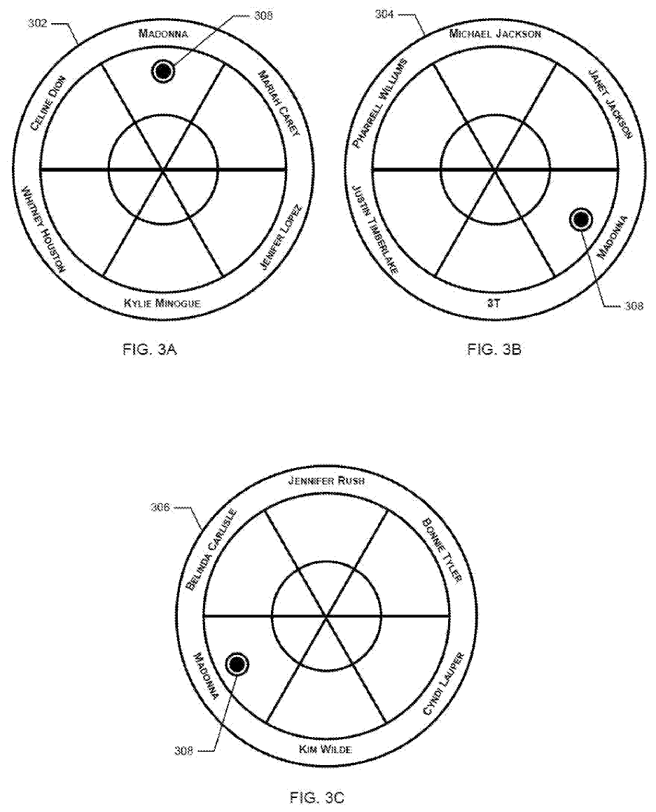

In an exemplary implementation, in case the visual maps overlapping with the associated attributes exist above a predefined threshold limit of, say, 2 (two) visual maps, then top 3 pre-set visual maps 302, 304, and 306 can be retrieved, as shown in FIG. 3A-3C. In an example, the pre-set visual maps can be one or a combination of one dimensional and two dimensional visual maps. The retrieved pre-set visual maps can be a Cartesian or a Polar coordinate system based model for classification of the attributes. Each pre-set visual map, in an exemplary instance, may be segmented into even-sized, say, 6 (six) portions representing one of the attributes connected based on contextual association to ‘Madonna’. As shown in FIGS. 3A-3C, each portion represents an artist, as one of the attributes. For example, the six portions in FIG. 3A of a pre-set map 302 can represent Madonna, Maria Carey, Jennifer Lope, Kylie Minogue, Whitney Houstan, and Celine Dion, as one of the attributes which are contextually linked to the searched query ‘Madonna’. Exemplary contextual relationships between these singers are common retrieved attributes including a female singer, an American singer, a song writer, a performer, genre: pop and rock, YOR: 1979-present, and so forth. In an example, the system 104 may arrange the retrieved 3 or 4 pre-set visual maps using their ranking based on one of a social ranking, a user ranking, or an aggregate of both social and user rankings. Rankings of the pre-set visual maps can be performed based on any of existing ranking mechanisms or techniques. In an embodiment, the maps can be ranked based on their contextual overlap/relevance to the data element being searched for and/or with the attributes associated with the data element, wherein the map having the maximum/highest overlap/relevant, for instance, can be ranked the highest, say by associating the highest weight to the map. Such overlap, in an instance, can be determined based on data elements that form part of the map, and the number of data elements and/or attributes thereof that overlap with the data element (and its associated attributes) being searched for. For instance, if the searched data element is Madonna, map having the maximum number of Madonna songs, or maximum number of songs of singers that have attributes in common with Madonna would have the highest rating. The other example includes wherein based on the user's historical choice, the user have liked the songs of other artists of Celine Dion, Mariah Carey, Whitney Houston, Kylie Minogue, Michael Jackson, Janet Jackson, Pharrell Williams, and Kim Wilde, then it can be seen that the Pre-set map 302 will have 4 liked artists connected to Madonna, and the Pre-set map 304 will have 3 liked artists connected to Madonna while the Pre-set Map 306 will have one liked artist connected to Madonna. Thus in this case the ranking of Pre-set maps being recommended to the user will follow the order from 302,304 and 306. The other scenario may include wherein the Preset map 302 has received the highest likes from the other users connected in the social network, followed by the Pre-set map 304 and 306 then the ranking of the visual maps being recommended to the user who has inputted the search query of Madonna will follow the order from 302,304 and 306. Based on such assigned rankings, the retrieved pre-set visual maps 302, 304, and 306 may be arranged. Further, although the pre-set visual maps 302, 304, and 306 are shown in circular shape, but these maps can have any other suitable shapes.

In an alternative implementation, in case the number of ascertained pre-set visual maps exists below the predefined threshold, the system 104 may generate visual maps automatically with an algorithm to create contextual relationship visual maps subject to results derived from the pre-defined rules. The said rules may be previously stored in the database and the said rules may get updated by the experts or the curators in the real time along with the new additions of the rules and may be used to extract contextual data elements related to data element received in the search query as an output from the pre-defined rules. Further, the said rules may include predefined logical rules for establishing the respective contextual relationship, where the logical rules are defined by experts or established by rules extracted from social and user-specific engagements, and the logical rules may be updated in real time for the changes in existing rules and for the additions of new rules and are based on one of mood, genres, mixed genres, activity, year of release, month of release, similar artist, similar rhythm type, language, featured artists, and instrumental tone. In present alternative implementation, system of the present disclosure may automatically generate visual maps by searching and retrieving, in or from the database, other singers having contextual relationship with ‘Madonna’ being data element received in the search query, followed by establishing and categorizing the result of different contextual relationships among ‘Madonna’ with retrieved singers (e.g. Michael Jackson or Bonnie Taylor) that are found under a common contextual relationship. Then, for each of the established and categorized relationship, computation and assignment of weights are performed for each of Madonna, Michael, and Bonnie to arrange them in an ascending or descending order on the visual maps. In an example, weights of Madonna, Michael, and Bonnie are ranked based on an aggregated value derived from the ranking related inputs from the experts along with the ranking related inputs gathered from social and user interactions. Based on the computed and assigned weights to each of Madonna, Michael, and Bonnie, a number of different visual maps categorized on the grounds of matching of the similar context are generated by incorporating ‘Madonna’ in combination with the contextual Michael and Bonnie that are selected based on their rankings within each of the category. In an example, the resulted visual maps are one or a combination of one dimensional visual maps and two dimensional visual maps. The resulted visual maps are being a Cartesian coordinate system based model or a Polar coordinate system based model for classification of the attributes, each visual map being segmented into even-sized portions and is always representing the searched Madonna, Michael, and Bonnie with any associated attribute and connected with related data elements with any associated attributes. In an example, in case only one visual map can be composed automatically, that only visual map is then generated.

Now, once the visual maps are retrieved or generated automatically, the system 104 may assign a starting point 308 at a first coordinate on the visual maps 302, 304, and 306 for recommending the playlist. In an example, the starting point 308 can be representing a most popular music track of queried data element ‘Madonna’ received in the search query that forms part of the selected map. Or, in an alternative example, the starting point 308 may represent or representing the data element (say, music track) received in the search query in combination with its related attributes, and can be corresponding to the highest rank of the computed weight of the said combination.

Following affixing of the starting point 308, in each retrieved or generated visual maps 302, 304, and 306, weights may be assigned to all the data elements (or music tracks) present on the visual maps 302, 304, and 306. In an example, the weights for each data element (or music track) can be representative of an aggregated value derived from the respective rankings based on their inputs derived from the ranking related inputs from the experts along with the ranking related inputs gathered from social and user interactions. In other words, the weights may be represented based on popularity of a data element or music track. In another aspect, as each recommended map comprises one or more data elements, the proposed system can select at least a set of data elements from the one or more data element, and logically connect the selected set of data elements to form the recommended playlist for the user based on user profile or user preferences or user's historical interactions, wherein the set of selected data elements are connected so as to form a trajectory to be presented as the playlist to the user, wherein the trajectory comprises a first data element that is representative of starting point of the trajectory, and wherein the first data element pertains to the data element received as part of the search query.

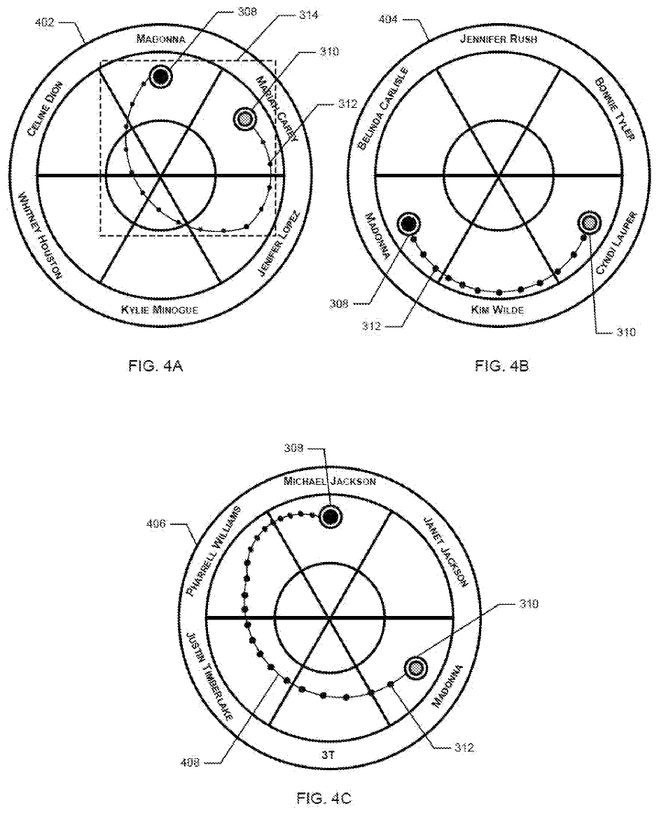

In an example, data elements or music tracks having highest weights and being connected with respective attributes can be selected and arranged in a particular ascending or descending order from the starting point 308. Further, as shown in FIGS. 4A-4C, based on the selected and arranged music tracks having highest weights, the system 104 may affix an end point 310 equalling the lowest value of the selected music tracks and representing the respective end music track at a second coordinate and one or more predefined intermediate points 312 equalling the intermediate values of the selected music tracks and representing one or more intermediate music tracks at one or more intermediate coordinates between the first coordinate and the second coordinate. In an example, the affixation of the end point and the intermediate points is performed in such a way that each of the even-sized portions is covered by a mathematical spline function 314 representing playlist trajectory connecting the starting point 308 and the end point 310 through the one or more predefined number of the intermediate points 312.

Thereafter, the coordinates associated with the starting point 308, the end point 310, and the one or more predefined number of the intermediate points 312, may be calculated as control points in the mathematical spline function 314. The calculation of the control points may be followed by displaying visual maps 402, 404, and 406, as shown in FIGS. 4A, 4B, 4C, and along with respective contextual relationship and recommended playlist trajectory 408 covering the said coordinates required to form the mathematical spline function 314. In an example, the visual maps 402, 404, and 406 may be displayed respectively in a decreasing ranking order, in which the calculation of the rank of the visual maps is based on an aggregated value derived from the ranking related inputs from the experts along with the ranking related inputs gathered from social and user interactions.

Once the visual maps 402, 404, and 406 are displayed on the GUI 106, the user may be allowed to steer/control/update the recommended playlist trajectory 408 using calculated controls points in the mathematical spline function 314. Thus, with the implementation of the system 104 of the present disclosure, changing the recommended playlist trajectory 408 resulting in different music tracks to be included in the recommended playlist trajectory 408 is very user friendly. In essence only the computed control points, possibly only one of the steering points or control points have to be moved using the GUI 106.

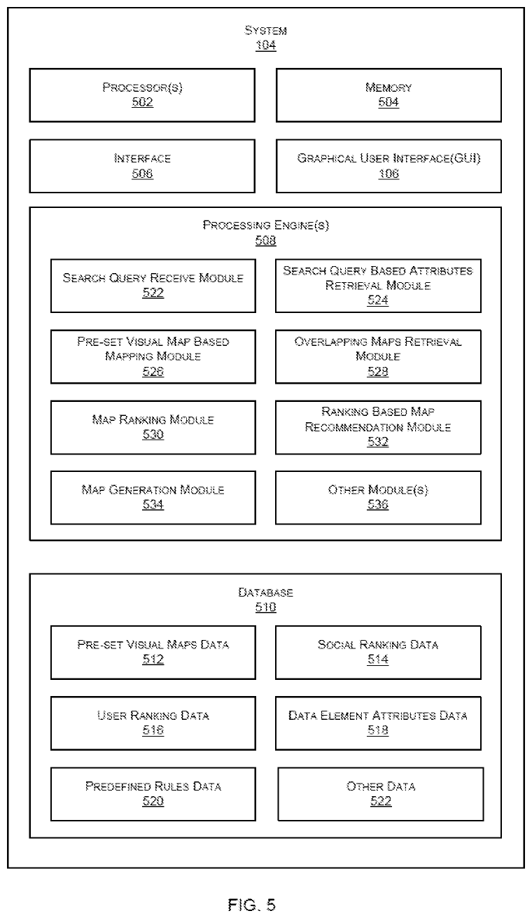

In an aspect, working and operation of the system 104 is further detailed with reference to FIG. 5 that illustrates various components of a proposed system 104. In an example, the system 104 may be implemented in a server. The server can include one or more computers operating as an online content streaming server, a web server, a network server, a data server, or other type of computer server in a manner to fulfil described roles, responsibilities, or functions of the system 104 proposed herein. The system 104 may be in communication with a user device 102 through the communication network 108 as discussed above.

The system 104 may include one or more processor(s) 502. The one or more processor(s) 502 may be implemented as one or more microprocessors, microcomputers, microcontrollers, digital signal processors, central processing units, logic circuitries, and/or any devices that manipulate data based on operational instructions. Among other capabilities, the one or more processor(s) 502 may be configured to fetch and execute computer-readable instructions stored in a memory 504 of the system 104. The memory 504 may store one or more computer-readable instructions or routines, which may be fetched and executed to create or share the recommended playlist over the GUI 106. The memory 504 may include any non-transitory storage device including, for example, volatile memory such as Random Access Memory (RAM), or non-volatile memory such as Erasable Programmable Read-Only Memory (EPROM), flash memory, and the like.

Further, as mentioned above, the system 104 may include the GUI 106. Apart from GUI 106, the system 104 may include an interface(s) 506. The interface(s) 506 may include a variety of interfaces, for example, interfaces for data input and output devices, referred to as I/O devices, storage devices, and the like. The interface(s) 506 may facilitate communication of the system 104 with various devices coupled to the system 104. The interface(s) 506 may also provide a communication pathway for one or more components of the system 104. Examples of such components include, but are not limited to, processing engine(s) 508 and the database 510. The database 510 may include pre-set visual maps data 512, social ranking data 514, user ranking data 516, data element attributes data 518, predefined rules data 520, and other data 522 that is either stored or generated as a result of functionalities implemented by any of the components of the processing engine(s) 508. Although the database 510 is represented as a part of the system 104, the database 510 or a part of it can be maintained using cloud computing. Further, in an example, it may be feasible to provide the network connected user device 102 with a facility to locally cache or store pre-set or automatically generated visual maps based on user's past history of generating a playlist of data elements.

Yet further, the processing engine(s) 508 may be implemented as a combination of hardware and programming (for example, programmable instructions) to implement one or more functionalities of the processing engine(s) 508. In examples described herein, such combinations of hardware and programming may be implemented in several different ways. For example, the programming for the processing engine(s) 508 may be processor executable instructions stored on a non-transitory machine-readable storage medium and the hardware for the processing engine(s) 508 may include a processing resource (for example, one or more processors), to execute such instructions. In the present examples, the machine-readable storage medium may store instructions that, when executed by the processing resource, implement the processing engine(s) 508. In such examples, the system 104 may include the machine-readable storage medium storing the instructions and the processing resource to execute the instructions, or the machine-readable storage medium may be separate but accessible to system 104 and the processing resource. In other examples, the processing engine(s) 508 may be implemented by electronic circuitry.

In an example, the processing engine(s) 508 may include a search query receive module 522, which when executed by the one or more processors, receives a search query comprising at least one data element or at least one attribute associated with the data element, a search query based attributes retrieval module 524, which when executed by the one or more processors, searches and retrieves, in or from a database, attributes associated with at least one data element; a pre-set visual map based mapping module 526, which when executed by the one or more processors, maps the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. In an aspect, in case the response to the step of ascertaining is affirmative, the proposed system can further include an overlapping maps retrieval module 528 configured to retrieve the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association; a map ranking module 530 configured to compute and assign weights to each of the retrieved pre-set visual maps based on the extent of contextual overlap or relevance between the search query and the respective pre-set visual map, the highest weight/rank being associated with the map having maximum overlap or relevance; and a ranking based map recommendation module 532 configured to recommend, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

It should be appreciated that above-mentioned modules are completely exemplary in nature and any number of other modules 536 can be configured or even the mentioned modules can be grouped together or divided into sub-modules, all of which possible implementations are well within the scope of the present invention.

In an aspect, each of the one or more data elements that form part of each recommended pre-set visual map can be associated with a weight based on the user profile or user preferences in a manner such that the data element with the highest weight becomes the first data element and the starting point of the trajectory. In an instance, data elements that have an associated weight lower than a defined threshold do not form part of the trajectory.

In an aspect, the user profile can include any or a combination of historical data elements that formed part of previously recommended playlists, user demographic profile, and user psychographic profile. In another aspect, the attributes can include any or a combination of artist's name, artist's gender, artist's language, artist's country of origin, artist's genre type, contribution of the artist among the three types of original artist, cover artist or featured artist, a single genre type, a mixed genre type, a mood type, a valence of mood type, a language, rhythm related inputs type, an activity type, version type among original, explicit, extended, cover or remix, year of release, month of release, and an instrumental related inputs type.

In yet another aspect, the pre-set visual maps can be previously prepared and saved in the database by any or both of an expert and the user, wherein the pre-set visual maps can be ranked based on one of a social ranking, a user ranking, or an aggregate of both social and user rankings. In an aspect, the database can be updated in real-time for the addition of new pre-set visual maps by the experts or the users.

In an aspect, the search query can be received in the form of or processed from any or a combination of a keyword, a video clip, an image, or an audio, wherein the can be search query is processed through a network based voice service that is coupled to the computing device capable of processing a voice based search query.

In an aspect, the proposed system can further be configured to locally cache, at the computing device, the meta-data representing at least one attribute of the data element while the playlist has been recommended to the user; and process the local cache when a further search query is received from the user.

As mentioned above, in an instance, the retrieved pre-set visual map having the highest weight is recommended first to the user.

In an exemplary aspect, the other engine(s) 536 may implement functionalities that supplement applications or functions performed by the system 104 or the processing engine(s) 508.

In operation, a smart device (user device 102) which is used by a user, say, Mr. Bob for accessing an online music streaming portal. Let us consider that Mr. Bob being a fan of Madonna and likes to listen her song. Then, Mr. Bob may enter the name of music track ‘Take a Bow’ in the query receiving field 202 in the GUI 106, upon receipt of which, module 524 may query the database 510 for searching and retrieving attributes associated with the queried music track ‘Take a Bow’. In an example, attributes associated with music track ‘Take a Bow’ can include, but not limited to, Artist: Madonna, YOR: 1994, MOR: November, Genre: Pop+rhythm and blues, American Singer, Mid-tempo, and so forth.

Using the queried music track ‘Take a Bow’ and associated attributes, module 526/528 may ascertain, in real time, whether any pre-set maps for queried music track ‘Take a Bow’ and associated attributes are present or previously stored in the database 510, wherein in case any pre-set maps are ascertained, said maps are ranked by module 530 based on their contextual relevance with the search query, and recommended by module 532 based on the assigned rank. One or more data elements that form part of each map can then be selected/weighted/ranked based on user profile/preference and/or historical data elements chosen/preferred/selected by the user so as to enable a playlist of a subset of data elements to be formed and connected to each other based on assigned weight, such connection forming a trajectory to be presented in the form of a playlist to the user.

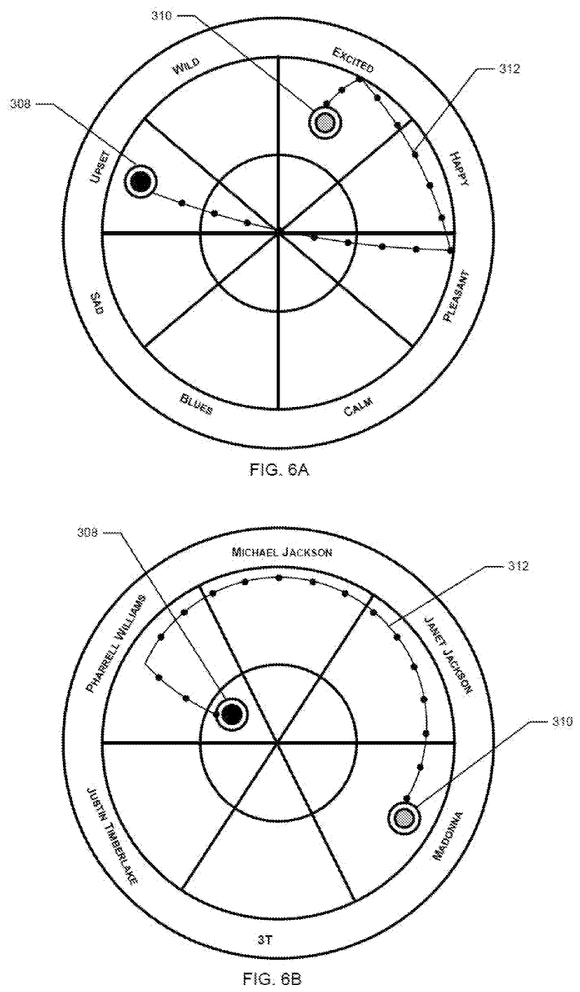

As mentioned previously, the pre-set visual maps can be a Cartesian or a Polar coordinate system based model for classification of the attributes. Each pre-set visual map can be segmented into even-sized portions representing one of the attributes connected based on contextual association to the searched query. In one example, where attribute is mood, each portion may represent different moods of ‘Madonna’. For example, FIG. 6A represents mood map with eight (8) different moods or emotions including sad, upset, wild, excited, happy, pleasant, calm, and blues. In another case, where attribute is represented by artist, each portion may represent different artists. For example, FIG. 6B represents artist map with six (6) different artists including Madonna, 3T, Justin Timberlake, Pharrell Williams, Janet Jackson and Michael Jackson.

Further, the pre-set visual maps may be previously prepared and saved in the database 510 by one of the expert and the user (Mr. Bob in the present case). In an example, the pre-set visual maps can be ranked based on any or a combination of their contextual relevance to the received search query (i.e. data element(s) and respective attributes), a social ranking, a user ranking. Extent of overlap between the data element received as part of the search query and the data elements that form part of each visual map, for instance, defines the rank/weight for the map. More the overlap as being ascertained by the higher rank/weight, higher will be the rank of recommendation for the respective visual map. Further, each of the pre-set visual maps can be one of a circular-shaped map, square-shaped map, and a rectangular-shaped map. The pre-set visual maps can be one or a combination of one dimensional and two dimensional visual maps. It would be appreciated that pre-set visual maps as defined in the specification may be created by various users, experts or even automatically by the proposed system that form part of the system and stored in a cloud/central repository.

As mentioned above, during implementation of the proposed system, for instance, if a total of 20,000 visual maps are stored in the database, upon receipt of a search query having a data element, mapping is done between the search query based data element and the stored visual maps so as to identify maps that comprise at least a threshold number of data elements, or map with attributes of the searched data element to a configured threshold extent, based on which, for instance, 20 maps can be identified to qualify the defined criteria/parameters, which can then be ranked/recommended/weighted based on how relevant/contextually overlapping they are with the searched data element(s) or attributes thereof. In case a desired number of maps are not available, system of the present disclosure can search for relevant data elements/attributes and automatically generate one or more maps, each of which can again be ranked/recommended based on contextual relevance.

In an aspect, in case the database 510 includes less than 3 (three) pre-set visual maps (i.e. less than a defined number of maps), the map generation module 534 may generate visual maps automatically with an algorithm to create visual maps with a varied contextual relationships subject to results derived from the pre-defined rules 520. The said rules may be previously stored in the database 510 and the said rules may get updated in the real time along with the new additions of the rules and these rules may be used to extract contextual relationships related to the queried data element as an output from the said pre-defined rules. Further, these said rules may include predefined logical rules for establishing the respective contextual relationship, where the logical rules are defined by the experts or established by rules extracted from social and user-specific engagements, and the logical rules may be updated in real time for the changes in existing rules and for the additions of new rules and are based on one of mood, genres, mixed genres, activity type, year of release, month of release, similar artists, similar rhythm type, language type, featured artist(s) which may have been involved, and instrumental tone type, for example, acoustic, piano etc. With the predefined rules 520, the map generation module 534 may automatically generate visual maps by searching and retrieving, in or from the database 510, other attributes having contextual relationship to the queried music track for example ‘Take a Bow’, followed by establishing and categorizing the result of different contextual relationships among queried music track ‘Take a Bow’ with retrieved attributes (e.g. Artist: Madonna, American Singer, YOR: 1994, MOR: November, Genre: Pop+Rhythm and Blues, slow-tempo, Mood: Melancholy, and so forth) that are found under a common contextual relationship. Then, for each of the established and categorized relationship, computation and assignment of weights are performed for each of retrieved attributes to arrange them in an ascending or descending order on the visual maps. In an example, weights of the attributes are ranked based on an aggregated value derived from the ranking related inputs from the experts along with the ranking related inputs gathered from social and user interactions. Based on the computed and assigned weights to attributes, a number of different visual maps categorized on the grounds of matching of the similar context are generated by incorporating queried music track ‘Take a Bow’ in combination with the contextual attributes that are selected based on their rankings within each of the category. In an example, the resulting visual maps can be a one-dimensional or two-dimensional or a combination of single dimensional and two dimensional visual maps. For example, the resulted visual maps can be a Polar coordinate system based model for classification of the attributes, each visual map being segmented into even-sized portions or sectors as shown in FIGS. 6A and 6B. There is a scenario that in case if there are few contextual attributes (with respect to the data element being searched) that are selected based on the rankings of these contextual attributes then there can be a possibility of having no classification of attributes in respective portions on some of the recommended visual maps. Also there may exist a possibility where only one visual map can be automatically generated due to scarcity of the contextual attributes related to the queried data element.

Now, once the recommended visual maps are retrieved from the database 510 and/or generated automatically using the predefined rules 520, the map recommendation module 532 can, using the map ranking module 530, rank the retrieved or generated visual maps based on their contextual overlap with the searched data element (and attributes thereof). Playlisting path of how data elements present in each map may also be changed in real-time based on user preferences, user profile, user attributes, historical data elements selected by the user, amongst the other user experience based parameters. As a part of updating the playlisting path, each data element of each recommended maps can be ranked/weighted based on its preference of being played by the user, such that the highest ranked data element can, for instance, be of the same singer/artist/genre/mixed genre/activity type entered by the user as part of the search query. Data elements that are not preferred by the user or disliked by the user can be eliminated so as to update the playlisting path or the trajectory in real-time. The input that how a user interacts with recommended maps and data elements that form part of the same can also be used for future recommendations to the user. In an exemplary aspect, the recommendation module 532 may assign a starting point 308 at a first coordinate on the visual maps. In an example, in FIG. 6A the starting point 308 can be representing the queried music track ‘Take a Bow’. Or, in an alternative example, a most similar music track of ‘Madonna’ to the track being queried to ‘Take a Bow’ is represented by the starting point 308 in case the queried music track ‘Take a Bow’ is not found in the database 510. As suggested above, the most popular music track may be searched from the database 510 using a combination of related attributes of the queried music track.

Following affixing of the starting point 308, in each retrieved or generated visual maps, the map recommendation module 532 may assign weight to all the music tracks (data elements) present on the visual maps. In an example, the weights for each music track can be representative of an aggregated value derived from the respective rankings based on their inputs derived from the ranking related inputs from the experts along with the ranking related inputs gathered from social and user interactions, or from user profile/preferences as mentioned above. In other words, the weights may be represented based on the popularity level of the searched data element and the respective attributes of the said data element thereof.

In an example, within a playlist music tracks having the highest weights and being connected with respective attributes can be selected and arranged in a particular ascending or descending order from the starting point 308. Based on the selected and arranged music tracks having the highest weights, the recommendation module 532 may affix an end point 310 equalling the lowest value of the selected music tracks and representing the respective end music track at a second coordinate and one or more predefined intermediate points 312 equalling the intermediate values of the selected music tracks and representing one or more intermediate music tracks at one or more intermediate coordinates between the first coordinate and the second coordinate. In an example, the affixation of the end point 310 and the intermediate points 312 may be performed in such a way that each of the even-sized or the odd-sized portions/sectors within the visual map is covered by a mathematical spline function 314 representing playlist trajectory connecting the starting point, 308 and the end point, 310 through the one or more predefined number of the intermediate points 312.

Thereafter, the coordinates associated with the starting point 308, the end point 310, and the one or more predefined number of the intermediate points 312, may be calculated as control points in the mathematical spline function 314 by the recommendation module 532. The calculation of the control points may be followed by displaying visual maps, and along with respective contextual relationship and recommended playlist trajectory covering the said coordinates required to form the mathematical spline function 314. In an example, the visual maps 402, 404, and 406 may be recommended respectively in a decreasing ranking order, in which the calculation of the rank of the visual maps is based on an aggregated value derived from the ranking related inputs from the experts along with the ranking related inputs gathered from social and user interactions.

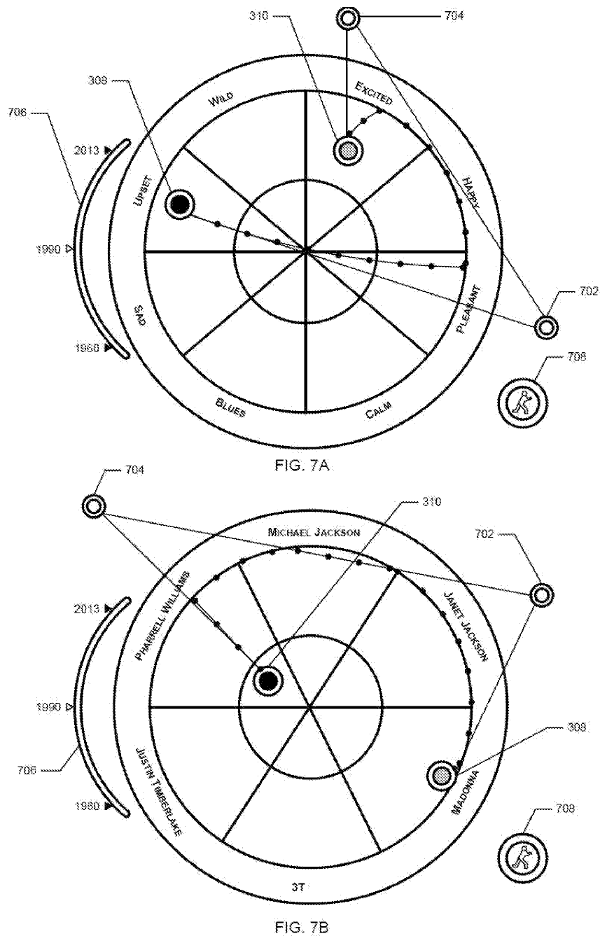

Once the visual maps are displayed on GUI 106, the user may be allowed to steer/control/update/fine tune the recommended playlist trajectory 408 using the controls points 301,308,702, and 704 in the mathematical spline function 314, as shown in FIGS. 7A and 7B. In an aspect, it may be possible that for the purpose of editing the displayed playlist, the mathematical spline function 314 may be produced on the visual maps by clicking on the displayed visual maps in a series of steps. For instance, a first click as a first user input may always correspond to selecting and changing the starting point 308, a second click as a second user input may correspond to selecting and changing the end point 310, a third click as a third user input may correspond to the to selecting and changing the control point from one of the remaining two control points, 702, and if there is a fourth click as a fourth user input, then it will correspond to the remaining control point, 704, of the spline function that defines the playlist. It may be programmed to restrict the number of clicks in this proposed method of editing the represented recommended playlist on the GUI 106. For example, the starting point corresponding to the data element being searched may not be selected and changed.

In yet another aspect, the user may control or modify the recommended playlist by voice enabled commands processed through the voice assisted devices coupled to the system 104. In an example, the voice assisted devices may include, but not limited to smartphone, smart TV, wearable devices, vehicles' voice assistant devices, or a cloud based service.

In an aspect, at the time of representing the recommended playlist on GUI 106, the GUI 106 may include a decade selector 706 to further filter the music tracks to a particular YOR or MOR, or to a range of two different limits on YOR/MOR.

In another aspect, the GUI 106 may include a playlist generation button 708 which when pressed or touched or clicked by a user may finalize the recommended playlist and create a final playlist for playing the music tracks in accordance with the created playlist.

Thus, with the implementation of the system 104 of the present disclosure, changing the initially recommended playlist trajectory 408 resulting in different music tracks to be included in the desired playlist 408 is very user friendly. To fine-tune the playlist, the control points 702, 704 may have to be moved outside the outer periphery of the visual map. This may pose a challenge, in case of small GUI, for example of GUI of a car display screen, as there may not be a sufficient space to steer the control points 702, 704 outside the geometry, such as a circle, of the visual map. This is because the control points 702, 704 may get restricted to go beyond what is allowable within the maximum height and width of the monitor/display screen. In such case, the system 104 may shrink boundary of the geometrical shape of the visual map so that the control points 702, 704 will find sufficient space to go outside the geometrical shape of the visual map to fine tune the desired playlist.

Further, although the description herein is focussed majorly on artist visual maps represent in FIGS. 3A-3C, 4A-4C, and 6A-6B, but the present disclosure is equally applicable to other visual maps including, but not limited to mood maps, genre maps, decade maps, tempo maps, or hybrid maps.

An exemplary mood map is shown in FIG. 6A. FIG. 6B illustrates an exemplary artist map. For example, FIG. 6B represents artist map for the year of release of the tracks ranging from 1960 to 2013 for the six (6) different artists including Madonna, 3T, Justin Timberlake, Pharrell Williams, Janet Jackson and Michael Jackson.

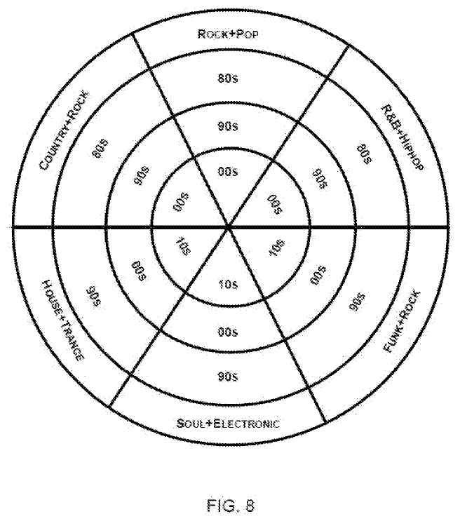

FIG. 8 illustrates a mixed genre map showing 6 (six) different mixed genres showing three different decades in the radial direction for each of the mixed genre. Each portion/sector in this visual map is shown to include a combination of two genres that include Housre+Trance, Country+Rock, Rock+Pop, R&B+Hiphop, Funk+Rock, and Soul+Electronic.

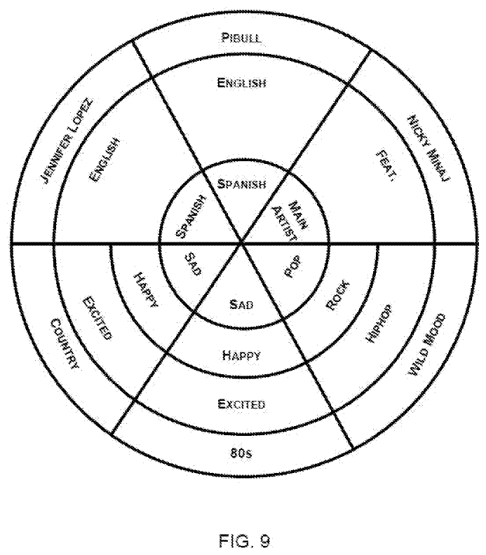

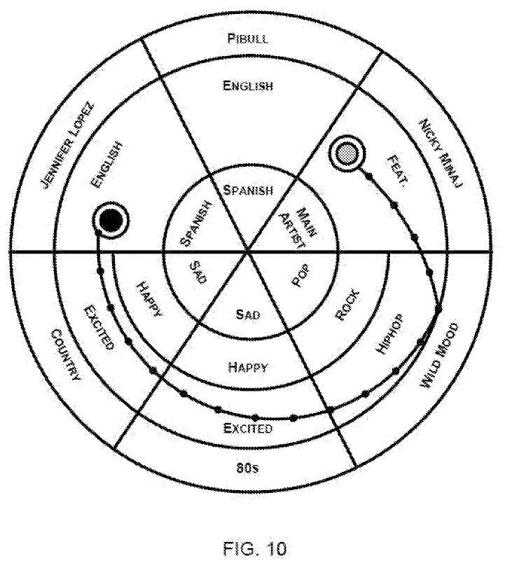

FIG. 9 illustrates another exemplary for the recommended hybrid map where the number and the type of the attribute varies for each of the data element in the visual map. In this hybrid map of FIG. 9, for the two artists—Jennifer Lopez and Pitbull, the two radial dimensions are English songs and Spanish songs, for the artist Nicky Minaj two variable attributes in the radial direction are for the songs wherein Nicky Minaj performed as a featured artist and for the songs wherein she performed as a main artist. Further, for the wild mood, three variable attributes are three different genres—Hiphop, Rock and Pop respectively. On the other hand, for two different primary dimension of 80s decade and the Country Music as a Genre, three dependent attributes of different moods—Excited, Happy and Sad moods are radially arranged in FIG. 9. Exemplary hybrid map of FIG. 9 is shown with control points in FIG. 10.

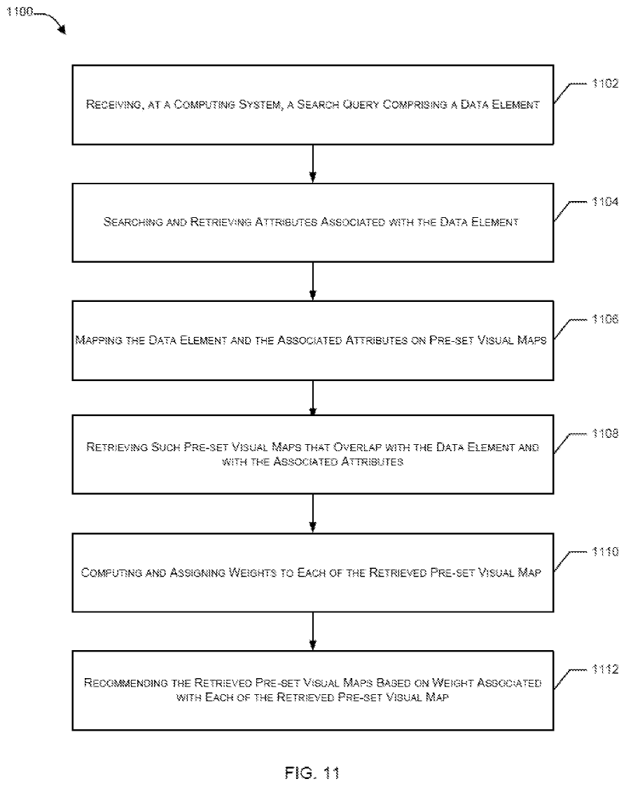

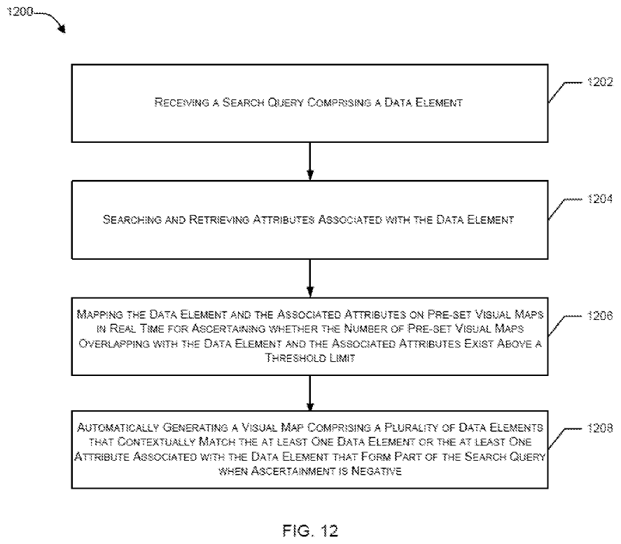

FIGS. 11-12 illustrate example methods 1100 and 1200, respectively, for recommending a playlist comprising a plurality of data elements. The order in which the methods 1100 and 1200 are described is not intended to be construed as a limitation, and any number of the described method blocks may be combined in any order to implement the methods, or an alternative method. Furthermore, methods 1100 and 1200 may be implemented by processing resource or computing device(s) through any suitable hardware, non-transitory machine readable instructions, or combination thereof.

It may also be understood that methods 1100 and 1200 may be performed by programmed computing devices, such as computing device(s) 102 or system 104 as depicted in FIGS. 1 and 5. Furthermore, the methods 1100 and 1200 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 1100 and 1200 are described below with reference to system(s) as described above; other suitable systems for the execution of these methods may also be utilized. Additionally, implementation of these methods is not limited to such examples.

In an aspect, step 1102 comprises receiving, at a computing system, a search query comprising at least one data element or at least one attribute associated with the data element; step 1104 comprises searching and retrieving, in or from a database operatively coupled with the computing system over a network, attributes associated with at least one data element; step 1106 comprises mapping the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps. At step 1108, if the number of pre-set visual maps that overlap with the data element and with the associated attributes is above a predefined threshold limit within the database, the proposed method can execute retrieving the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association; and, at step 1110, computing and assigning weights to each of the retrieved pre-set visual maps based on the extent of contextual overlap or relevance between the search query and the respective pre-set visual map, the highest weight being associated with the map having maximum overlap or relevance; and at step 1112, recommending, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

In an aspect, each of the one or more data elements that form part of each recommended pre-set visual map can be associated with a weight based on the user profile or user preferences in a manner such that the data element with the highest weight becomes the first data element and the starting point of the trajectory, wherein data elements that have an associated weight lower than a defined threshold do not form part of the trajectory.

In an aspect, the user profile can include any or a combination of historical data elements that formed part of previously recommended playlists, user demographic profile, and user psychographic profile.

In another aspect, the attributes can include any or a combination of artist's name, artist's gender, artist's language, artist's country of origin, artist's preferred genre type, contribution of the artist that can be found among the three types of original artist, cover artist or featured artist, a single genre type of the song, a mixed genre type of the song, a mood type, a valence of mood type, a language, rhythm related inputs type, an activity type, version type of the song among original, explicit, extended, cover or remix, year of release, month of release, and an instrumental related inputs type.

In another aspect, the pre-set visual maps can be previously prepared and saved in the database by any or both of an expert and the user, and wherein the pre-set visual maps are ranked based on one of a social ranking, a user ranking, or an aggregate of both social and user rankings, wherein the database can be updated in real-time for the addition of new pre-set visual maps by the experts or the users.

In an aspect, the search query can be received in the form of any or a combination of a keyword, a video clip, an image, or an audio. The search query can be processed through a network based voice service that can be coupled to the computing device capable of processing a voice based search query. In another aspect, the data element can be one of a music track, an audio song, a video, a photo, a news item, and informative item, a game, an e-book, and an e-cartoon. In an aspect, type of mood, or intensity of mood, or variation of tempo, or language or year of release falling within a particular decade of the data elements represented in the pre-set visual maps varies in a radial or a linear direction from centre of the pre-set visual maps to the outer periphery of the pre-set visual maps. In another aspect, each of the pre-set visual maps is one of a circular-shaped map, square-shaped map, and a rectangular-shaped map.

In an aspect, the proposed method can further include the step of locally caching, at the computing device, the meta-data representing at least one attribute of the data element while the playlist has been recommended to the user; and processing the local cache when a further search query is received from the user.

In an aspect, the retrieved pre-set visual map having the highest weight can be recommended first to the user.

In an aspect, step 1202 comprises receiving, at a computing system, a search query comprising at least one data element or at least one attribute associated with the data element; at step 1204, searching and retrieving, in or from a database operatively coupled with the computing system over a network, attributes associated with the at least one data element; and at 1206, mapping the data element and the associated attributes on pre-set visual maps in real time for ascertaining whether the number of pre-set visual maps overlapping with the data element and the associated attributes exist above a threshold limit within the database. At step 1208, in response to negative ascertaining, the proposed method can automatically generate a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query.

In an aspect, each of the set of data elements can be associated with a weight based on their contextual relationship or relevance to the at least one data element or the at least one attribute associated with the data element that form part of the search query, wherein the plurality of data elements are selected from the set of data elements based on the associated weight. In another aspect, each of the plurality of data elements can be associated with a rank based on user profile or user preferences such that starting point of the trajectory is the data element having the highest rank.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “receiving” or “extracting” or “storing” or “generating” or the like, refer to the action and processes of a computing machine, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to a system/device for performing the operations discussed herein above. This system/apparatus/device may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The terminology used herein is for the purpose of describing particular embodiments only and is not intended to be limiting of the present disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1-34. (canceled)

35. A computer implemented method (1100) for recommending a playlist comprising a plurality of data elements, each of said plurality of data elements being associated with meta data representing at least one attribute of the data element, said method comprising:
receiving (1102), at a computing system, a search query comprising at least one data element or at least one attribute associated with the data element;
searching and retrieving (1104), in or from a database operatively coupled with the computing system over a network, attributes associated with at least one data element;
mapping (1106) the data element and the associated attributes on pre-set visual maps in real time for ascertaining whether the number of pre-set visual maps that overlap with the data element and with the associated attributes is above a predefined threshold limit within the database, wherein the mapped pre-set visual maps comprise any or a combination of one-dimensional and two-dimensional visual maps;
in response to affirmative ascertaining, retrieving (1108) the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association;
computing and assigning (1110) weights to each of the retrieved pre-set visual maps based on the extent of contextual overlap or relevance between the search query and the respective pre-set visual map, the highest weight being associated with the map having maximum overlap or relevance;
recommending (1112), to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

36. The method (1100) of claim 35, wherein each of the one or more data elements that form part of each recommended pre-set visual map is associated with a weight based on the user profile or user preferences in a manner such that the data element with the highest weight becomes the first data element and the starting point of the trajectory.

37. The method (1100) of claim 35, wherein the pre-set visual maps are previously prepared and saved in the database by any or both of an expert and the user, and wherein the pre-set visual maps are ranked based on one of a social ranking, a user ranking, or an aggregate of both social and user rankings.

38. The method (1100) of claim 35, wherein the search query is received in the form of or processed from any or a combination of a keyword, a video clip, an image, or an audio.

39. The method (1100) of claim 35, wherein the search query is processed through a network based voice service that is coupled to the computing device capable of processing a voice based search query.

40. The method (1100) of claim 35, wherein each of the pre-set visual maps is one of a circular-shaped map, square-shaped map, and a rectangular-shaped map.

41. The method (1100) of claim 35, further comprising the step of locally caching, at the computing device, the meta-data representing at least one attribute of the data element while the playlist has been recommended to the user; and processing the local cache when a further search query is received from the user.

42. The method (1100) of claim 35, wherein the retrieved pre-set visual map having the highest weight is recommended first to the user.

43. A computer implemented method (1200) for recommending a playlist comprising a plurality of data elements, each of said plurality of data elements being associated with metadata representing at least one attribute of the data element, said method comprising:
receiving (1202), at a computing system, a search query comprising at least one data element or at least one attribute associated with the data element;
searching and retrieving (1204), in or from a database operatively coupled with the computing system over a network, attributes associated with the at least one data element;
mapping (1206) the data element and the associated attributes on pre-set visual maps in real time for ascertaining whether the number of pre-set visual maps overlapping with the data element and the associated attributes exist above a threshold limit within the database;
in response to negative ascertaining, automatically generating (1208) a visual map comprising a plurality of data elements that contextually match the at least one data element or the at least one attribute associated with the data element that form part of the search query, said plurality of data elements being selected from a set of data elements that are stored in the database, and wherein the plurality of data elements are connected with each other in a defined trajectory so as to form the playlist, and wherein the trajectory comprises a first data element that is representative of starting point of the trajectory, and wherein the first data element pertains to the data element received as part of the search query.

44. The method (1200) of claim 43, wherein each of the set of data elements are associated with a weight based on their contextual relationship or relevance to the at least one data element or the at least one attribute associated with the data element that form part of the search query, wherein the plurality of data elements are selected from the set of data elements based on the associated weight.

45. The method (1200) of claim 43, wherein each of the plurality of data elements are associated with a rank based on user profile or user preferences such that starting point of the trajectory is the data element having the highest rank.

46. A system (104) for recommending a playlist comprising a plurality of data elements, each of said plurality of data elements being associated with metadata representing at least one attribute of the data element, said system (104) comprising:
a non-transitory storage device having embodied therein one or more routines operable to recommend the playlist; and
one or more processors (502) coupled to the non-transitory storage device and operable to execute the one or more routines, wherein the one or more routines include:
a search query receive module (522), which when executed by the one or more processors (502), receives a search query comprising at least one data element or at least one attribute associated with the data element;
a search query based attributes retrieval module (524), which when executed by the one or more processors (502), searches and retrieves, in or from a database (510), attributes associated with at least one data element;
a pre-set visual map based mapping module (526), which when executed by the one or more processors (502), maps the data element and the associated attributes on pre-set visual maps in real time for ascertaining whether the number of pre-set visual maps that overlap with the data element and with the associated attributes is above a predefined threshold limit within the database (510), wherein the mapped pre-set visual maps comprise any or a combination of one-dimensional and two-dimensional visual maps, wherein in response to affirmative ascertaining, said system (104):
retrieves the pre-set visual maps that overlap with the data element and with the associated attributes, wherein the retrieved pre-set visual maps comprise a Cartesian or a Polar coordinate system based model for classification of the attributes, each retrieved pre-set visual map being segmented into portions representing at least one of the attributes connected to the searched query based on contextual association;
computes and assigns weights to each of the retrieved pre-set visual maps based on the extent of contextual overlap or relevance between the search query and the respective pre-set visual map, the highest weight being associated with the map having maximum overlap or relevance;
recommends, to a user, the retrieved pre-set visual maps based on weight associated with each of the retrieved pre-set visual maps, each recommended map comprising one or more data elements, at least a set of which data elements being logically connected to form the recommended playlist for the user based on user profile or user preferences, said set of selected data elements being connected so as to form a trajectory to be presented as the playlist to the user, wherein the trajectory comprises a first data element that is representative of starting point of the trajectory, and wherein the first data element pertains to the data element received as part of the search query.

47. The system (104) of claim 46, wherein each of the one or more data elements that form part of each recommended pre-set visual map is associated with a weight based on the user profile or user preferences in a manner such that the data element with the highest weight becomes the first data element and the starting point of the trajectory.

48. The system (104) of claim 46, wherein the pre-set visual maps are previously prepared and saved in the database (510) by any or both of an expert and the user, and wherein the pre-set visual maps are ranked based on one of a social ranking, a user ranking, or an aggregate of both social and user rankings.

49. The system (104) of claim 46, wherein the search query is processed through a network based voice service that is coupled to the computing device capable of processing a voice based search query.

50. The system (104) of claim 46, further comprising the step of locally caching, at the computing device, the meta-data representing at least one attribute of the data element while the playlist has recommended to the user; and processing the local cache when a further search query is received from the user.

51. The system (104) of claim 46, wherein the retrieved pre-set visual map having the highest weight is recommended first to the user.

52. A system (104) for recommending a playlist comprising a plurality of data elements, each of said plurality of data elements being associated with metadata representing at least one attribute of the data element, said system (104) comprising:
a search query receive module (522), which when executed by the one or more processors (502), receives a search query comprising at least one data element or at least one attribute associated with the data element;
a search query based attributes retrieval module (524), which when executed by the one or more processors (502), searches and retrieves, in or from a database (510), attributes associated with at least one data element;
a pre-set visual map based mapping module (526), which when executed by the one or more processors (502), maps the data element and the associated attributes on pre-set visual maps in real time for ascertaining whether the number of pre-set visual maps that overlap with the data element and with the associated attributes is above a predefined threshold limit within the database (510), wherein in response to negative ascertaining, said system (104):
automatically generates a visual map comprising a plurality of data elements that contextually match the at least one data element or the at least one attribute associated with the data element that form part of the search query, said plurality of data elements being selected from a set of data elements that are stored in the database (510), and wherein the plurality of data elements are connected with each other in a defined trajectory so as to form the playlist, and wherein the trajectory comprises a first data element that is representative of starting point of the trajectory, and wherein the first data element pertains to the data element received as part of the search query.

53. The system (104) of claim 52, wherein each of the set of data elements are associated with a weight based on their contextual relationship or relevance to the at least one data element or the at least one attribute associated with the data element that form part of the search query, wherein the plurality of data elements are selected from the set of data elements based on the associated weight.
